(19) United States
(12) Patent Application Publication
(10) Pub. No.: US 2014/0217720 A1
(43) Pub. Date: Aug. 7, 2014

(54) PIPE INSULATING JOINT

(71) Applicant: Meir Levy, Eilat (IL)

(72) Inventor: Meir Levy, Eilat (IL)

(73) Assignee: MEKOROT WATER COMPANY, LTD, Tel-Aviv (IL)

(21) Appl. No.: 14/238,660

(22) PCT Filed: Aug. 14, 2012
(86) PCT No.: PCT/IL2012/050312

§ 371 Date: Feb. 12, 2014

Related U.S. Application Data
(60) Provisional application No. 61/525,952, filed on Aug. 22, 2011.

(51) Int. Cl. F16L 25/02

(52) U.S. Cl. CPC F16L 25/02
USPC 285/47

(57) ABSTRACT

Provided is a pipe insulating joint for insulating in between a first pipe element and a second pipe element, wherein at least one of which includes an electrical current impressed therein. The pipe insulating joint including a pipe segment having a wall portion made of an electrical insulating material and coupling means for coupling the pipe segment between the first pipe element and the second pipe element, such that the electrical current is not transferred therebetween.

### FIELD OF THE DISCLOSED SUBJECT MATTER

The present disclosed subject matter relates to a pipe insulating joint in general and, in particular, to a pipe insulating joint for pipelines having a cathodic protection.

### BACKGROUND OF THE DISCLOSED SUBJECT MATTER

One of the common challenges in pipelines maintenance is avoiding corrosion of the various metal parts of the pipeline, which occurs during an oxidation process therein. Corrosion in pipelines which are used for conveyance and/or distribution of gas, water and hydrocarbons can result in damages to the pipeline, such as leaks, and other damages.

A known solution for corrosion is cathodic protection, which, in the case of pipelines, is carried out, for example, by forming an anode site electrically coupled to a pipe line element and impressing current through the body of the pipeline elements. The current, which is impressed between the various pipe elements and an anode site, is greater than the current present during the oxidation process. This forces a reversal of the current, and causes the anode to be consumed by the corrosion rather than the pipeline element.

When using an impressed current, the size of the pipeline structure determines the amount of amperage required, as well as the speed in which the anodes are consumed by the corrosion. Thus, when the pipeline structure is coupled to other elements, such as other pipeline structures an appropriate insulation is required, so as to ensure that the impressed current passes only through the desired structure. For example, in a case of a pipeline structure of a water company delivering water to private consumers, insulation between the pipeline of the water company and the pipeline elements of the private consumer is required. The insulation limits the amount of amperage to the amount required to protect only the pipeline structure of the water company. In addition, the insulation precludes corrosion from the pipeline elements of the various private consumers to be acclimated at the anode site.

### SUMMARY OF THE PRESENT DISCLOSED SUBJECT MATTER

The present disclosed subject matter provides a pipe insulating joint for insulting in between a first pipe element and a second pipe element, wherein at least one of which includes an electrical current impressed therein. The pipe insulating joint comprising a pipe segment having a wall portion made of an electrical insulating material and coupling means for coupling the pipe segment between the first pipe element and the second pipe element, such that the electrical current is not transferred therebetween.

The coupling means can includes a first flange for coupling to a corresponding flange of the first pipe element. The coupling means can further comprise a second flange for coupling to a corresponding flange of the second pipe element.

The first flange and the second flange can be made of an electrical conductive material. The pipe segment can be configured for coupling more than two pipe elements thereto.

The insulating pipe can further comprise at least one retaining rim defined about at least a portion of the circumference of the wall portion and configured for retaining one of the first flange and second flange on the pipe segment when fastened to an adjacent pipe element. The insulating pipe can further comprise at least one raised portion defined at least about a portion of the circumference of the wall portion in close proximity to the at least one rim, such that one of the first flange and second flange can be disposed and retained therebetween.

The insulating pipe can further comprise a reinforcing element configured for providing the wall portion with durability and stability so as to withstand the pressure of a fluid delivered through the pipe segment. The reinforcing element can be a plurality of rings disposed about the circumference of said wall portion.

The insulating pipe can further comprise a protector disposed about at least a portion of the periphery of the wall portion and configured to prevent damage thereof. The protector can be a pair of semicylindrical shells. The protector can be made of a perforated sheet.

The insulating pipe can further comprise an insulating portion between the protector and one of the coupling means and second flange. The insulating portion is defined by the raised portion described hereinabove.

The present disclosed subject matter provides a method for forming a chatodic protection for a first pipeline structure having at least one pipe element being coupled to a second pipeline structure through the pipe element. The method comprising electrically coupling an anode site to the first pipeline structure; mounting a pipe insulating joint between the pipe element and the second pipeline structure for insulting therebetween. The pipe insulating joint comprises a pipe segment having a wall portion made of an electrical insulating material and coupling means for fastening a first end of the pipe segment to the pipe element and a second end thereof to the second pipeline structure. The method further comprising impressing electrical current through the first pipeline structure.

The coupling means can comprise a first flange for coupling to a corresponding flange of the pipe element. The coupling means can further comprise a second flange for coupling to a corresponding flange of the second pipeline structure.

The first flange and the second flange are made of an electrical conductive material.

The method can further comprise forming at least one retaining rim about at least a portion of the circumference of the wall portion and configured for retaining one of the first flange and second flange on the pipe segment when fastened to an adjacent pipe element.

The method can further comprise forming at least one raised portion defined at least about a portion of the circumference of the wall portion in close proximity to the at least one rim, such that one of the first flange and second flange can be disposed and retained therebetween.

The method can further comprise providing a reinforcing element configured for providing the wall portion with durability and stability so as to withstand the pressure of a fluid delivered through the pipe segment. The reinforcing element can be a plurality of rings disposed about the circumference of the wall portion.

The method can further comprise providing a protector disposed about at least a portion of the periphery of the wall portion and configured to prevent damage thereof. The protector can be a pair of semicylindrical shells. The protector can be made of a perforated sheet.

### BRIEF DESCRIPTION OF THE DRAWINGS

In order to understand the disclosed subject matter and to see how it may be carried out in practice, an embodiment will now be described, by way of a non-limiting example only, with reference to the accompanying drawings, in which:

FIG. 1 is a side perspective view of insulating joint constructed an operative in accordance with one example of the presently disclosed subject matter;

FIG. 2 is a side view schematic illustration of the insulating joint of FIG. 1;

FIG. 3 is a front view schematic illustration of a flange of the pipe insulating joint of FIG. 1;

FIG. 4 is a perspective view of the pipe insulating joint of FIG. 1 coupled to a pipeline structure;

FIG. 5a is a side perspective view of pipe insulating joint constructed an operative in accordance with another example of the presently disclosed subject matter;

FIG. 5b is a side view schematic illustration of the pipe insulating joint of FIG. 5a;

FIG. 6 is a side perspective view of pipe insulating joint constructed an operative in accordance with another example of the presently disclosed subject matter;

FIG. 7a is a side perspective view of pipe insulating joint constructed of FIG. 5 having a protector partially disposed thereon; and,

FIG. 7b is a side perspective view of pipe insulating joint constructed of FIG. 7a with the protectors removed.

### DETAILED DESCRIPTION OF EMBODIMENT

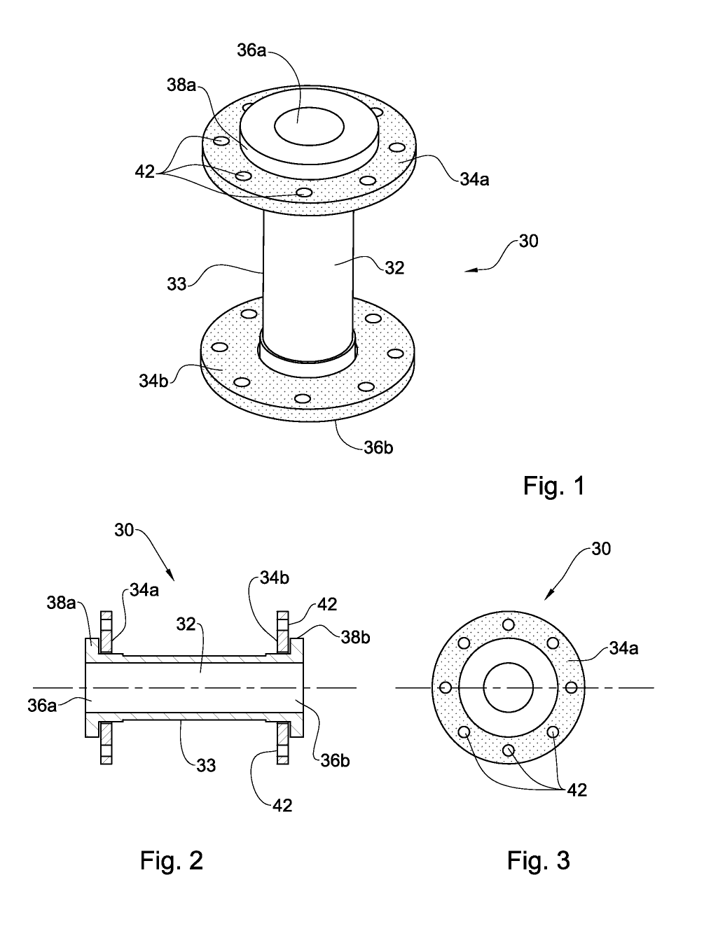

FIG. 1 shows a perspective view of a pipe insulating joint 30 constructive and operative in accordance with one example of the presently disclosed subject matter. Insulating joint 30 includes a pipe segment 32 made of an electrical insulating material, such as plastic, and coupling means, here illustrated as first and second flanges 34a and 34b for coupling the joint to other pipe elements (not shown). The first and second flanges 34a and 34b can be made of any material including a conductive material. The insulating material from which the pipe segment 32 is made can be a non-conductive or insulating material, or material which substantially eliminates the formation of an effective electric current, for example such that is used for eliminating corrosion of the pipe elements.

Pipe segment 32 includes a side wall portion 33, which can be a cylindrical wall, having a first opening 36a on a first end thereof, and a second opening 36b on a second end thereof. The first and second openings 36a and 36b are each configured for coupling to other pipe elements.

The length of the pipe segment 32 can be determined in accordance with the required insulation. That is to say, the length required in order to insulate against ion conduction caused by electrolyte in the fluid transferred through the pipe segment. For example, in case salty fluid is delivered through the pipeline structure an electric current may be formed by the ionic fluid between different segments of the pipeline. Due to the potential gradient, this current can be formed even in case the two segments are not adjacent one another, and thus are not directly electrically coupled. Thus, the length of the insulating joint 30 can be selected so as to overcome the potential gradient and avoid such ionic current.

The inner diameter of the pipe segment 32 can be determined in accordance with the inner diameter of the pipe elements to which the insolating joint 30 is to be coupled, and/or the required pressure. The width of the side wall portion 33 is such that it can withstand the pressure gradient inside the pipeline. It is appreciated that the width of the side wall portion 33 can vary in accordance with the strength of the martial from which the pipe segment 32 is formed.

It is appreciated the flow parameters of the pipe segment, e.g. section through the pipe segment, surface quality, etc., are such so as to substantially not interfere with fluid flow regime through the pipe segment.

Insulating joint 30 includes a retainer in the form of an outwardly protruding rim 38a, for retaining flange 34a on pipe segment 32. Rim 38a can be defined about the periphery of the opening 36a or at any other location along the length of the pipe segment 32. The rim 38a can be defined along the entire circumference of the pipe segment 32 or along a portion thereof. Similarly, flange 34b is retained on pipe segment 32 by a rim 38b defined about the periphery of the opening 36b. As shown in FIG. 2, the height of rim 38a allows retaining the flange 34a in place, under the forces of fastening means securing the flange to a corresponding flange of an adjacent pipe element.

Each one of the first and second flanges 34a and 34b is configured to couple first and second openings 36a and 36b of insulating joint 30 to corresponding openings of adjacent pipe elements, respectively, having a corresponding flange.

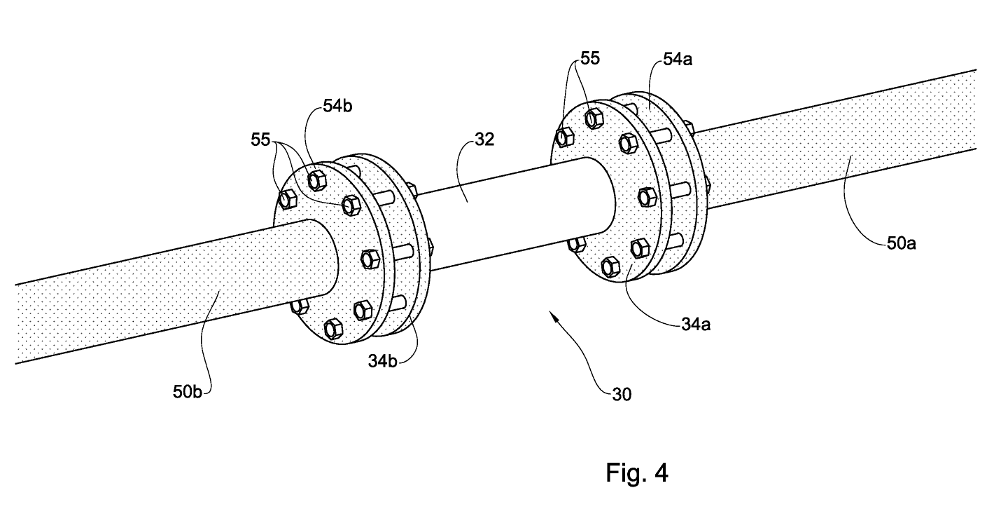

As shown in FIG. 3, each one of flanges 34a and 34b includes a plurality of bolt apertures 42 for receiving bolts for coupling to a corresponding flange of an adjacent pipe element. Alternatively, flanges 34a and 34b can include other fastening means for fastening to adjacent pipe elements having flange. It is appreciated that the joint insulator can include other fastening means for fastening thereof to adjacent pipe elements, such as various pipe coupling. The pipe coupling can be made of any material so long as the pipe coupling on one end of the insulting joint is not electrically coupled to the pipe coupling on the second end of the insulating joint, thus formation of current between the two ends of the insulating joint is eliminated. Referring now to FIG. 4, the insulating joint 30 can be used to insulate between a first pipe element 50a and a second pipe element 50b. The first pipe element 50a can be part of a first pipeline structure, such as a water company pipeline, and the second pipe element 50b can be a part of a second pipeline structure, such as a private consumer pipeline. One end of pipe segment 32 of the insulating joint 30 is coupled to the first pipe element 50a, and the other end thereof is coupled to the second pipe element 50b. Coupling pipe segment 32 to first and second pipe elements 50a and 50b can be carried out by inserting the pipe segment 32 into the first and second pipe elements 50a and 50b. In that case, the pipe segment 32 is formed with a diameter slightly smaller than the diameter of first and second pipe elements 50a and 50b. Alternatively, if the diameter of the pipe segment 32 is slightly larger than the diameter of first and second pipe elements 50a and 50b, first and second pipe elements 50a and 50b can be inserted into the pipe segment 32. It is appreciated that coupling the pipe segment 32 to the first and second pipe elements 50a and 50b can be carried out in any other fashion, as known.

Each one of the first and second pipe elements 50a and 50b includes a flange 54a and 54b, respectively, corresponding to the flange 34a and 34b of insulating joint 30. More specifically, flange 54a of pipe elements 50a corresponds to flange 34a of the insulating joint 30. A plurality of bolts 55 fasten flange 54a to flange 34a thereby securing insulating joint 30 in place, in relation to the first pipe element 50a. Flange 54b is fastened to flange 34b of the insulating joint 30, in a similar fashion, thereby securing the insulating joint 30 in place, in relation to the second pipe element 50b.

It is appreciated that the pipe elements 50a and 50b can be made of a conductive material and may have an electric current impressed therethrough. The electric current can be impressed, for example, through first pipeline structure to which the first pipe element 50a is coupled. Second pipe element 50b can have an electric current impressed there through, as well, however in any case, the existence of the insulating joint 30 precludes electric current flow between first and second pipe element 50a and 50b. Thus, due to the insulating material of the pipe segment 32 of the insulating joint 30, insulation between the first pipeline structure and the second pipeline structure is provided. As discussed hereinabove the length of pipe segment 32, is determined so as to preclude an ionic current between pipe elements 50a and 50b, transferred through the fluids conveyed there between. For example, the length can be determined such that the electric potential between the first and second pipe elements 50a and 50b is low enough and an ionic current can not be formed.

It is appreciated that the insulting joint can be configured to couple more than two pipe elements thereto, for example a T pipe joint, etc.

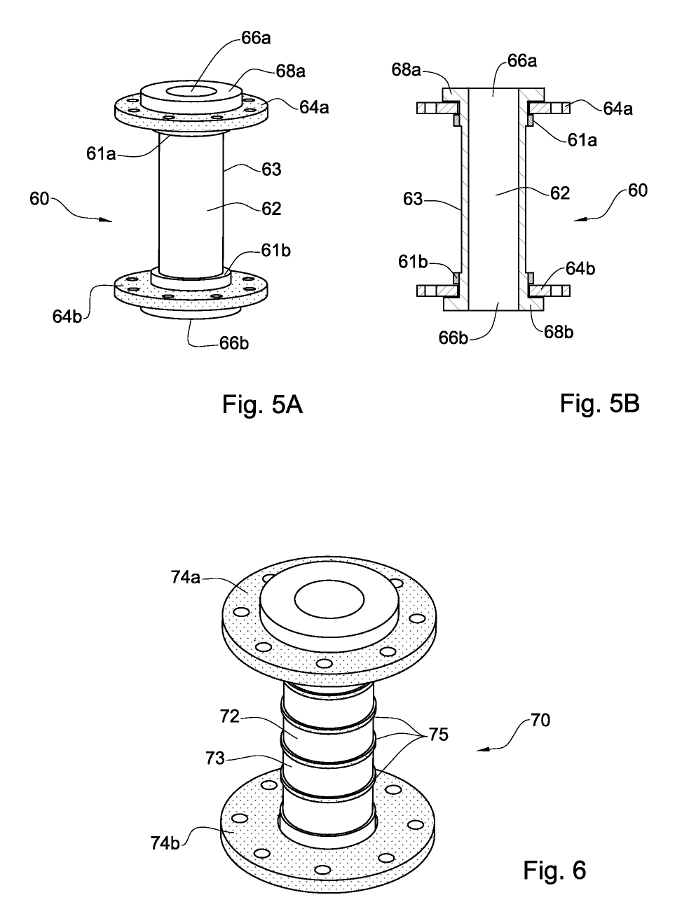

According to one example, shown in FIGS. 5A and 5B, an insulating joint 60 includes a pipe segment 62 having rims 68a and 68b at each end thereof, similar to those of insulating joint 30 of FIG. 1 and further having a pair of radial raised portions 61a defined in close proximity to rim 68a and 68b, respectively. A first flange 64a is disposed between the retaining rim 68a and the first raised portion 61a, and in a similar fashion, a second flange 64b is disposed between the retaining rim 68b and the second raised portion 61b. Raised portions 61a and 61b are defined at least about a portion of the circumference of the pipe segment 62 in close proximity to rims 68a and 68b, such that the flange can be disposed and retained therebetween. This way, the flanges 64a and 64b are retained in place and the displacement thereof off the pipe segment 62, or away from their respective opening 66a or 66b, is precluded.

According to another example, each one of the flanges 64a and 64b can be retained in place by a radial groove formed about the periphery of pipe segment 62 for example at a close proximity to each of the openings 66a and 66b thereof. Each of the grooves is configured for retainably holding one of flanges 64a and 64b.

Alternatively, the flanges can be integrally formed with the pipe segment, or can be affixed thereto by welding, or by any other affixing or mounting method. Contrary to the material of the pipe segment, the flanges can be made of conductive material such as metal, for example similar to the material of the flanges of the other pipe element to which the insulating joint is coupled. It is appreciated though, that in case the flanges are made of a conductive material, they are not in contact with one another, so as to preclude electric current there between.

Reference is now made to FIG. 6, insulating joint 70 having a pipe segment 72 is similar to that shown in FIG. 1, having a wall portion 73, and a pair of flanges 74a and 74b. Pipe segment 72 further includes one or more reinforcing elements 75, here illustrated as a plurality of rings disposed about the circumference of the wall portion 73. The reinforcing elements are configured for providing the wall portion 73 with durability and stability so as to withstand the pressure of the fluid delivered through the pipe segment 72. It will be appreciated that the reinforcing elements 75 can be made of any material, including a conductive material, so long as an electric coupling is not formed between the two flanges 74a and 74b.

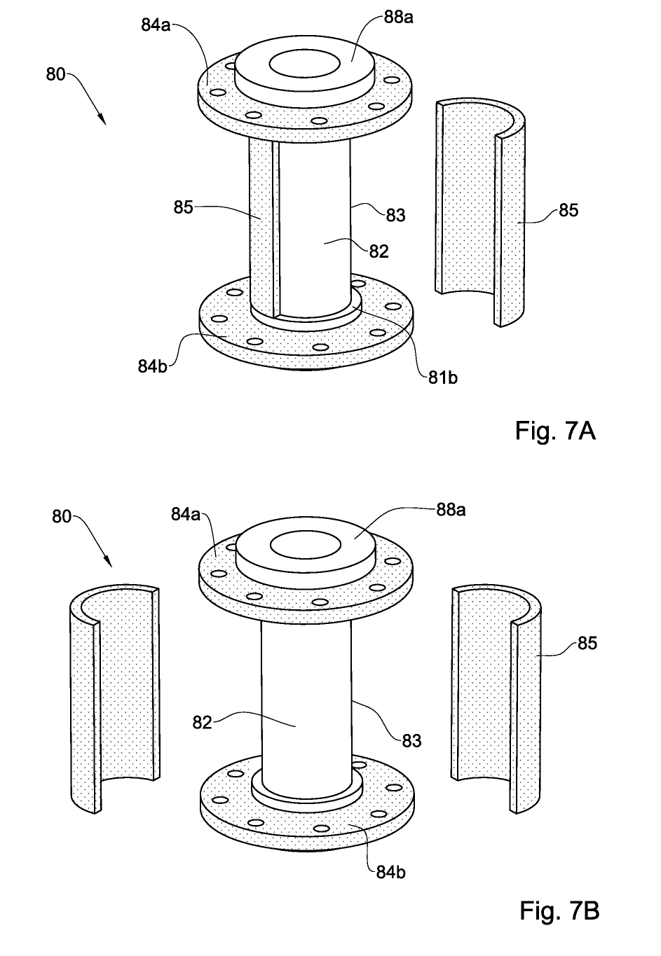

FIGS. 7a and 7b show another example of an insulting joint 80, similar to the one shown in FIGS. 5A and 5B, and having a pipe segment 82 defined by a wall portion 83, and a pair of flanges 84a and 84b. The flanges 84a and 84b are each, retained between one of rims 88a and 88b, at each end of the pipe segment 82 and one of the radial raised portions 81a and 81b defined in close proximity to the rims. The insulating joint 80 is further provided with a protector 85 disposed about at least a portion of the periphery of the wall portion 83. The protector 85 is configured to prevent a damage of the wall portion 83, such as drilling thereof by an unauthorized person, for example so as to connect a pipe segment thereto in order to steal water or other fluids delivered through the pipe segment 82. Since the pipe segment is made of a substantially non-conductive material, drilling thereof can be easier than drilling or damaging a conductive martial such as metal. Thus, the protector 85 can be made of any desired material such as metal.

In order to avoid electrical coupling of the two flanges 84a and 84b, by which an electrical current can be formed between the two pipe segments connected to the insulating joint, the protector 85 is disposed between the raised portions 81a and 81b. The raised portions 81a and 81b are made from a substantially non-conductive material for example the same material as the pipe segment 82, thus, precluding an electrical current between the two flanges 84a and 84b. It is appreciated that the raised portion can be configured and adapted to eliminate a formation of an electrical current even such which can be caused by an electromagnetic induction. Thus the raised portions 81a and 81b can have a width sufficient to substantially preclude any effective current. It is appreciated that any other insulating portions can be utilized for electrically insulating between the protector 85 and the flanges 84a and 84b.

According to the illustrated example, the protector 85 is formed of a pair of semicylindrical shells, adapted to be disposed about the periphery of the wall portion 83, forming together a cover protecting substantially the circumference of the wall portion 83. It is appreciated that the protector 85 can be made with any shape such as a rectangular, and can be made from a perforated sheet. The protector 85 is configured to make it difficult to access the wall portion 83 of the pipe segment 82, thus it does not have to cover the entire length or circumference thereof, rather it can be adapted to cover a majority thereof in such a way that it would be difficult for one to access the wall portion 83.

The two semi-cylindrical shells 87 can be welded to one another, can be glued to the wall portion 83, or can be coupled to the raised portions in any known way. According to one example, the semi-cylindrical shells 87 can be removably mounted, so as to allow removing thereof in case the insulating joint is to be removed or treated.

Those skilled in the art to which the presently disclosed subject matter pertains will readily appreciate that numerous changes, variations, and modifications can be made without departing from the scope of the invention, mutatis mutandis.

1-26. (canceled)

27. A pipe insulating joint for insulting in between a first pipe element and a second pipe element, wherein at least one of which includes an electrical current impressed therein, the pipe insulating joint comprising:
a pipe segment having a wall portion made of an electrical insulating material; and
coupling means for coupling the pipe segment between the first pipe element and the second pipe element, such that the electrical current is not transferred therebetween.

28. The pipe insulating joint of claim 27, wherein the coupling means comprises a first flange for coupling to a corresponding flange of the first pipe element.

29. The pipe insulating joint of claim 28, wherein the coupling means further comprises a second flange for coupling to a corresponding flange of the second pipe element.

30. The pipe insulating joint of claim 29, wherein said first flange and said second flange are made of an electrical conductive material.

31. The pipe insulating joint of claim 27, wherein the pipe segment is configured for coupling more than two pipe elements thereto.

32. The insulating pipe of claim 29, further comprising at least one retaining rim defined about at least a portion of a circumference of said wall portion and configured for retaining one of said first flange and second flange on said pipe segment when fastened to an adjacent pipe element.

33. The insulating pipe of claim 32, further comprising at least one raised portion defined at least about a portion of the circumference of said wall portion in close proximity to said at least one rim, such that one of said first flange and second flange can be disposed and retained therebetween.

34. The insulating pipe of claim 27, further comprising a reinforcing element configured for providing said wall portion with durability and stability so as to withstand pressure of a fluid delivered through said pipe segment.

35. The insulating pipe of claim 34, wherein said reinforcing element is a plurality of rings disposed about a circumference of said wall portion.

36. The insulating pipe of claim 32, further comprising a protector disposed about at least a portion of a periphery of said wall portion and configured to prevent damage thereof.

37. The insulating pipe of claim 36, wherein said protector is a pair of semicylindrical shells.

38. The insulating pipe of claim 36, wherein said protector is made of a perforated sheet.

39. The insulating pipe of claim 36, further comprising an insulating portion disposed between said protector and one of said coupling means and second flange.

40. The insulating pipe of claim 36, further comprising at least one raised portion defined at least about a portion of the circumference of said wall portion in close proximity to said at least one retaining rim, such that one of said first flange and second flange can be disposed and retained therebetween, wherein said insulating portion is defined by said raised portion.

41. A method for forming a cathodic protection for a first pipeline structure having at least one pipe element being coupled to a second pipeline structure through the pipe element, the method comprising:
electrically coupling an anode site to the first pipeline structure;
mounting a pipe insulating joint between the pipe element and the second pipeline structure for insulting therebetween, said pipe insulating joint comprises a pipe segment having a wall portion made of an electrical insulating material and coupling means for fastening a first end of said pipe segment to the pipe element and a second end thereof to the second pipeline structure; and
impressing electrical current through the first pipeline structure.

42. The method according to claim 41, wherein the coupling means comprises a first flange for coupling to a corresponding flange of the pipe element.

43. The method according to claim 42, wherein the coupling means further comprises a second flange for coupling to a corresponding flange of the second pipeline structure.

44. The method according to claim 43, wherein said first flange and said second flange are made of an electrical conductive material.

45. The method according to claim 43, further comprising forming at least one retaining rim defined about at least a portion of a circumference of said wall portion and configured for retaining one of said first flange and second flange on said pipe segment when fastened to an adjacent pipe element.

46. The method according to claim 45, further comprising forming at least one raised portion defined at least about a portion of the circumference of said wall portion in close proximity to said at least one rim, such that one of said first flange and second flange can be disposed and retained therebetween.
